(19) United States
(12) Patent Application Publication
(10) Pub. No.: US 2025/0124607 A1
(43) Pub. Date: Apr. 17, 2025

(54) IN-LOOP NEURAL NETWORKS FOR VIDEO CODING

(71) Applicant: MEDIATEK INC., Hsinchu City (TW)

(72) Inventors: Jan KLOPP, Hsinchu City (TW); Ching-Yeh CHEN, Hsinchu City (TW); Tzu-Der CHUANG, Hsinchu City (TW); Yu-Wen HUANG, Hsinchu City (TW)

(21) Appl. No.: 18/727,505

(22) PCT Filed: Jan. 12, 2023
(86) PCT No.: PCT/CN2023/071934

§ 371 Date: Jul. 9, 2024

Related U.S. Application Data
(60) Provisional application No. 63/299,058, filed on Jan. 13, 2022.
(60) Provisional application No. 63/369,085, filed on Jul. 22, 2022.

(51) Int. Cl. G06T 9/00; H04N 19/117; H04N 19/184

(52) U.S. Cl. CPC G06T 9/002; H04N 19/117; H04N 19/184

(57) ABSTRACT

A method for video decoding includes receiving a video frame reconstructed based on data received from a bitstream. The method further includes extracting, from the bitstream, a first syntax element indicating whether a spatial partition for partitioning the video frame is active. The method also includes, responsive to the first syntax element indicating that the spatial partition for partitioning the video frame is active, determining a configuration of the spatial partition for partitioning the video frame, determining a plurality of parameter sets of a neural network, and applying the neural network to the video frame. The video frame is spatially divided based on the determined configuration of the spatial partition for partitioning the video frame into a plurality of portions, and the neural network is applied to the plurality of portions in accordance with the determined plurality of parameter sets.

### CROSS REFERENCE TO RELATED APPLICATIONS

The present application claims priority to U.S. Provisional Application No. 63/299,058, “Multi-pass training for in-loop neural network filtering”, filed on Jan. 13, 2022, and U.S. Provisional Application No. 63/369,085, “Spatially divided training for in-loop neural network filtering”, filed on Jul. 22, 2022. The two U.S. Provisional applications are incorporated herein by reference in their entirety.

### TECHNICAL FIELD

The present disclosure relates generally to video coding. In particular, the disclosure relates to applying Neural Networks (NNs) to target signals in video encoding and decoding systems.

### BACKGROUND

A Neural Network, also referred as an “Artificial” Neural Network (ANN), is an information-processing system that has certain performance characteristics in common with a biological neural network. A Neural Network system is made up of a number of simple and highly interconnected processing elements to process information by their dynamic state response to external inputs. The processing element can be considered as a neuron in the human brain, where each perceptron accepts multiple inputs and computes weighted sum of the inputs. In the field of neural network, the perceptron is considered as a mathematical model of a biological neuron. Furthermore, these interconnected processing elements are often organized in layers. For recognition applications, the external inputs may correspond to patterns that are presented to the network, which communicates to one or more middle layers, also called “hidden layers”, where the actual processing is done via a system of weighted “connections”.

It is desirable to develop a low-complexity NN-based in-loop filter to enhance the performance of traditional codecs.

### SUMMARY

Aspects of the disclosure provide a method for video decoding. The method includes receiving a video frame reconstructed based on data received from a bitstream. The method further includes extracting, from the bitstream, a first syntax element indicating whether a spatial partition for partitioning the video frame is active. The method also includes, responsive to the first syntax element indicating that the spatial partition for partitioning the video frame is active, determining a configuration of the spatial partition for partitioning the video frame, determining a plurality of parameter sets of a neural network, and applying the neural network to the video frame. The video frame is spatially divided based on the determined configuration of the spatial partition for partitioning the video frame into a plurality of portions, and the neural network is applied to the plurality of portions in accordance with the determined plurality of parameter sets.

Aspects of the disclosure provide an apparatus for video decoding. The apparatus includes circuitry configured to receive a video frame reconstructed based on data received from a bitstream. The circuitry is further configured to extract, from the bitstream, a first syntax element indicating whether a spatial partition for partitioning the video frame is active. The circuitry is also configured to, responsive to the first syntax element indicating that the spatial partition for partitioning the video frame is active, determine a configuration of the spatial partition for partitioning the video frame, determine a plurality of parameter sets of a neural network, and apply the neural network to the video frame. The video frame is spatially divided based on the determined configuration into a plurality of portions, and the neural network is applied to one of the plurality of portions in accordance with each of the determined plurality of parameter sets.

Aspects of the disclosure provide another method for video encoding. The method includes receiving data representing a video frame. The method further includes determining a configuration of a spatial partition for partitioning the video frame. The method also includes determining a plurality of parameter sets of a neural network. In addition, the method includes applying the neural network to the video frame. The video frame is spatially divided based on the determined configuration into a plurality of portions, and the neural network is applied to the plurality of portions in accordance with the determined plurality of parameter sets. Moreover, the method includes signaling a plurality of syntax elements associated with the spatial partition for partitioning the video frame.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a video encoder based on the Versatile Video Coding (VVC) standard or the High Efficiency Video Coding (HEVC) standard (with an Adaptive Loop Filter (ALF) added);

FIG. 2 shows a block diagram of a video decoder based on the VVC standard or the HEVC standard (with an ALF added);

FIG. 3 shows a video frame containing a complex spatial variance distribution;

FIGS. 4A-4F show a number of exemplary spatial partitions implemented on a video frame, in accordance with embodiments of the disclosure;

FIG. 5 shows a flow chart of a process for implementing an NN-based in-loop filter in a video encoder, in accordance with embodiments of the disclosure;

FIG. 6 shows a flow chart of a process for implementing an NN-based in-loop filter in a video decoder, in accordance with embodiments of the disclosure;

FIG. 7 shows a block diagram of a multi-pass training process of a neural network in accordance with embodiments of the disclosure, in which a single parameter set is used in the multiple passes;

FIG. 8 shows a block diagram of a multi-pass training process of a neural network in accordance with embodiments of the disclosure, in which distinct parameter sets are used in the multiple passes; and

FIG. 9 shows a block diagram of a multi-pass training process of a neural network in accordance with embodiments of the disclosure, in which partially distinct parameter sets are used in the multiple passes.

### DETAILED DESCRIPTION OF EMBODIMENTS

The following disclosure provides different embodiments, or examples, for implementing different features of the provided subject matter. Specific examples of components and arrangements are described below to simplify the present disclosure. These are, of course, merely examples and are not intended to be limiting.

Artificial neural networks may use different architecture to specify what variables are involved in the network and their topological relationships. For example, the variables involved in a neural network might be the weights of the connections between the neurons, along with activities of the neurons. Feed-forward network is a type of neural network topology, where nodes in each layer are fed to the next stage and there is connection among nodes in the same layer. Most ANNs contain some form of “learning rule”, which modifies the weights of the connections according to the input patterns that it is presented with. In a sense, ANNs learn by example as do their biological counterparts. Backward propagation neural network is a more advanced neural network that allows backwards error propagation of weight adjustments. Consequently, the backward propagation neural network is capable of improving performance by minimizing the errors being fed backwards to the neural network.

The neural network can be a deep neural network (DNN), convolutional neural network (CNN), recurrent neural network (RNN), or other NN variations. Deep multi-layer neural networks or deep neural networks (DNN) correspond to neural networks having many levels of interconnected nodes allowing them to compactly represent highly non-linear and highly-varying functions. Nevertheless, the computational complexity for DNN grows rapidly along with the number of nodes associated with the large number of layers.

The CNN is a class of feed-forward artificial neural networks that is most commonly used for analyzing visual imagery. A recurrent neural network (RNN) is a class of artificial neural network where connections between nodes form a directed graph along a sequence. Unlike feedforward neural networks, RNNs can use their internal state (memory) to process sequences of inputs. The RNN may have loops in them so as to allow information to persist. The RNN allows operating over sequences of vectors, such as sequences in the input, the output, or both.

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC).

In HEVC, one slice is partitioned into multiple coding tree units (CTU). The CTU is further partitioned into multiple coding units (CUs) to adapt to various local characteristics. HEVC supports multiple Intra prediction modes and for Intra coded CU, the selected Intra prediction mode is signaled. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition. After prediction, the residues associated with the CU are partitioned into transform blocks, named transform units (TUs) for the transform process.

The HEVC standard specifies two in-loop filters, the Deblocking Filter (DF) for reducing the blocking artifacts and the Sample Adaptive Offset (SAO) for attenuating the ringing artifacts and correcting the local average intensity changes. Because of heavy bit-rate overhead, the final version of HEVC does not adopt the Adaptive Loop Filtering (ALF).

Compared to previous video coding standards such as HEVC, the Versatile Video Coding (VVC) standard developed by the Joint Video Experts Team (JVET) has been designed to achieve significantly improved compression capability, and to be highly versatile for effective use in a broadened range of applications. In VVC, the pictures are partitioned into Coding Tree Units (CTUs), which represent the basic coding processing units, also specified in HEVC. CTUs consist of one or three Coding Tree Blocks (CTBs) depending on whether the video signal is monochrome or contains three-color components.

In VVC, four different in-loop filters are specified: DF, SAO, ALF, and the Cross-Component Adaptive Loop Filtering (CC-ALF) for further correcting the signal based on linear filtering and adaptive clipping.

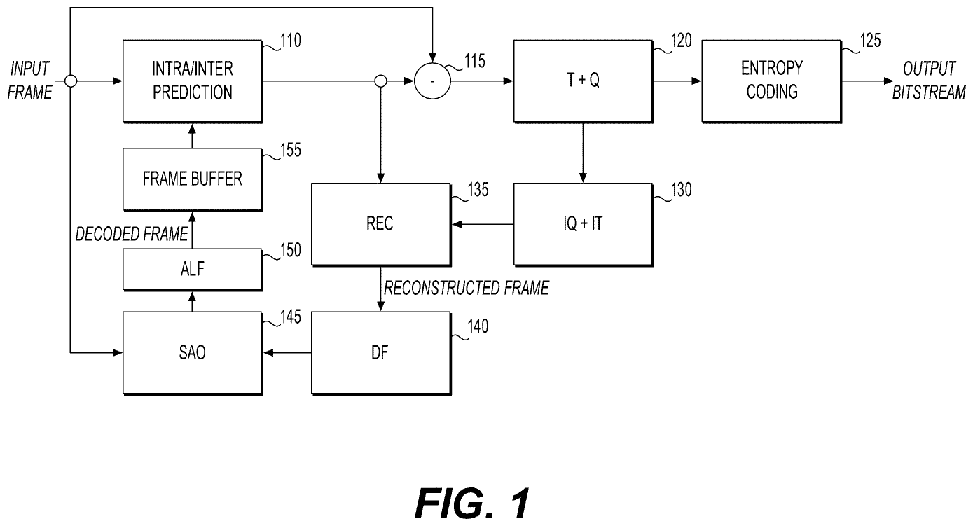

FIG. 1 shows a block diagram of a video encoder, which may be implemented based on the VVC standard, the HEVC standard (with ALF added) or any other video coding standard. The Intra/Inter Prediction unit 110 generates Inter prediction based on Motion Estimation (ME)/Motion Compensation (MC) when Inter mode is used. The Intra/Inter Prediction unit 110 generates Intra prediction when Intra mode is used. The Intra/Inter prediction data (i.e., the Intra/Inter prediction signal) is supplied to the subtractor 115 to form prediction errors, also called “residues” or “residual”, by subtracting the Intra/Inter prediction signal from the signal associated with the input frame. The process of generating the Intra/Inter prediction data is referred as the prediction process in this disclosure. The prediction error (i.e., the residual) is then processed by Transform (T) followed by Quantization (Q) (T+Q, 120). The transformed and quantized residues are then coded by Entropy Coding unit 125 to be included in a video bitstream corresponding to the compressed video data.

The bitstream associated with the transform coefficients is then packed with side information such as motion, coding modes, and other information associated with the image area. The side information may also be compressed by entropy coding to reduce required bandwidth. Since a reconstructed frame may be used as a reference frame for Inter prediction, a reference frame or frames have to be reconstructed at the encoder end as well. Consequently, the transformed and quantized residues are processed by Inverse Quantization (IQ) and Inverse Transformation (IT) (IQ+IT, 130) to recover the residues. The reconstructed residues are then added back to Intra/Inter prediction data at Reconstruction unit (REC) 135 to reconstruct video data. The process of adding the reconstructed residual to the Intra/Inter prediction signal is referred as the reconstruction process in this disclosure. The output frame from the reconstruction process is referred as the reconstructed frame.

In order to reduce artefacts in the reconstructed frame, in-loop filters, including but not limited to, DF 140, SAO 145, and ALF 150 are used. In this disclosure, DF, SAO, and ALF are all labeled as a filtering process. The filtered reconstructed frame at the output of all filtering processes is referred as a decoded frame in this disclosure. The decoded frames are stored in Frame Buffer 155 and used for prediction of other frames.

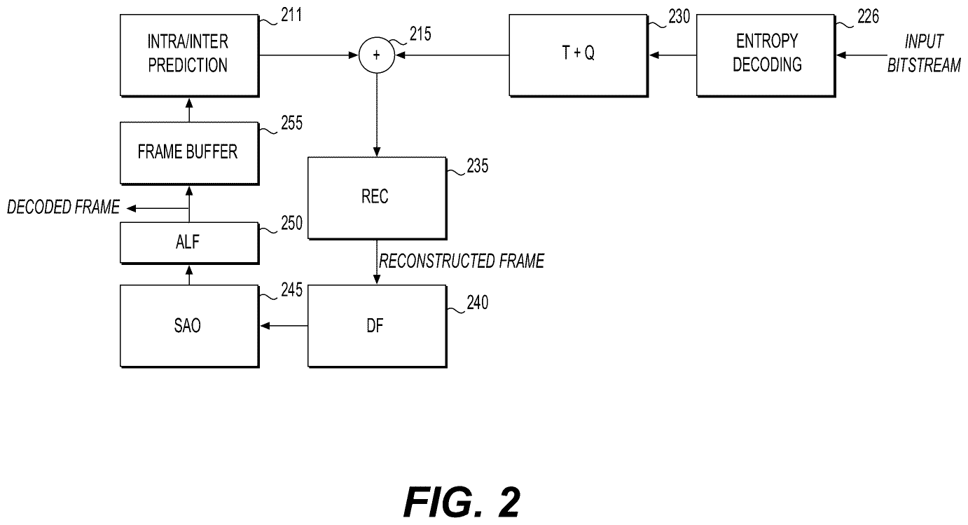

FIG. 2 shows a block diagram of a video decoder, which may be implemented based on the VVC standard, the HEVC standard (with ALF added) or any other video coding standard. Since the encoder contains a local decoder for reconstructing the video data, many decoder components are already used in the encoder except for the entropy decoder. At the decoder side, an Entropy Decoding unit 226 is used to recover coded symbols or syntaxes from the bitstream. The process of generating the reconstructed residual from the input bitstream is referred as a residual decoding process in this disclosure. The prediction process for generating the Intra/Inter prediction data is also applied at the decoder side, however, the Intra/Inter prediction unit 211 is different from the Intra/Inter prediction unit 110 in the encoder side since the Inter prediction only needs to perform motion compensation using motion information derived from the bitstream. Furthermore, an Adder 215 is used to add the reconstructed residues to the Intra/Inter prediction data.

Generally, embodiments of this disclosure relate to using neural networks to improve the image quality of video codecs. A neural network is deployed as a filtering process at both the encoder side and the decoder side. The parameters of the neural network are learned at the encoder, and transmitted in the bitstream to the decoder, together with a variety of information with respect to how to apply the neural network at the decoder side in accordance with the transmitted parameters.

The neural network operates at the same location of the loop in the decoder as in the encoder. This location can be chosen at the output of the reconstruction process, or at the output of one of the filtering processes. Taking the video codec shown in FIGS. 1 and 2 as an example, the neural network can be applied to the reconstructed signal from the Reconstruction unit 135/235, or the filtered reconstructed signal from any of DF 140/240, SAO 145/245, ALF 150/250, or the filtered reconstructed signal from any other type of in-loop filter. The specific location of the neural network can be predefined, or can be signaled from the encoder to the 35 decoder.

Note that the sequence of the filters DFs, SAOs, and ALFs shown in FIGS. 1 and 2 is not restrictive. Although three types of filters are illustrated here, it does not limit the scope of the present disclosure because less or more filters can be included.

Two sorts of variances are considered in designing a filtering tool with a neural network: a temporal variance, and a spatial variance. It is observed that the temporal variance is small across a random access segment (RAS); as a result, training a neural network on 128 frames can achieve almost the same coding gain as training 8 neural networks, each on 16 frames.

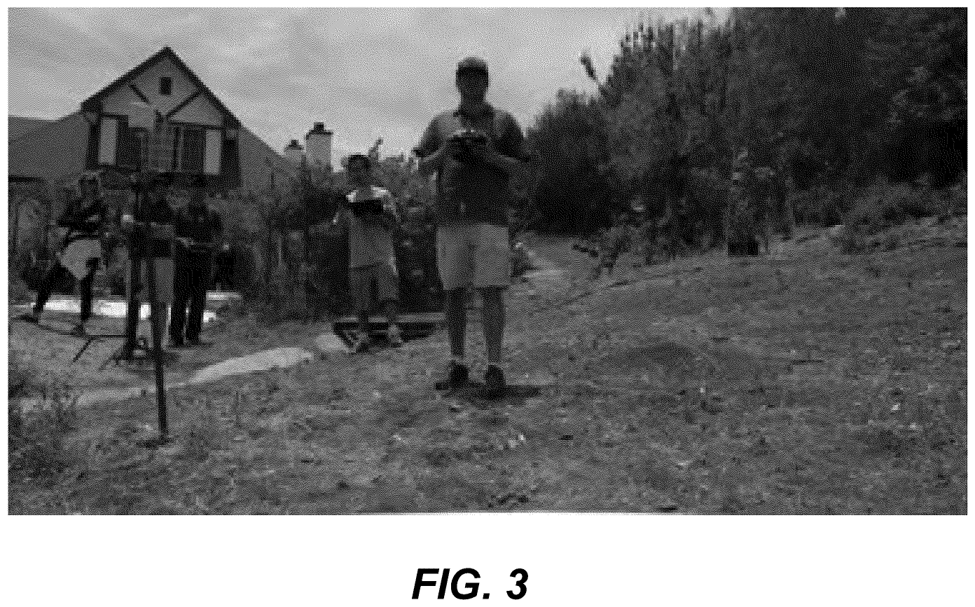

In contrast, the spatial variance is often large within a single frame. FIG. 3 shows a typical video frame with a complex spatial variance distribution. The top half of the image has various texture regions such as sky, buildings, trees, and people, while the content in the bottom half is comparatively homogeneous. This leads to different reconstruction error statistics that the neural network must learn in order to predict the error at each pixel of the image.

To account for different predictors required in different spatial areas, it is beneficial to divide the pixels in a frame into a number of portions, and train distinct neural network parameters for individual portions. As each portion has a specific parameter set that defines the predictor dedicated to the pixels within that particular portion, the parameter set fits the reconstruction error statistics of the relatively small portion very well. With this approach, a large coding gain can be achieved by a lightweight neural network with lower complexity and less computation cost.

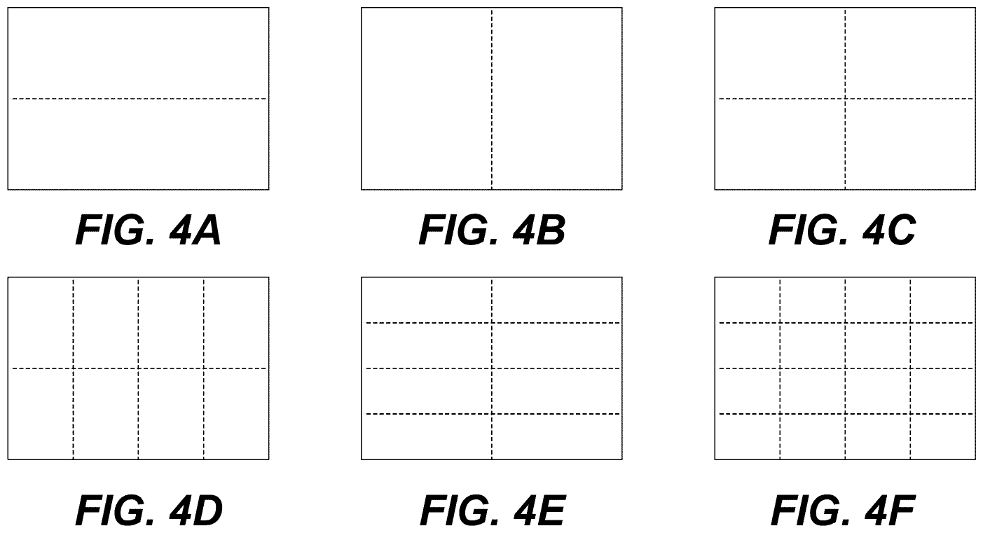

FIGS. 4A-4F illustrate a number of possible patterns for dividing the pixels in a frame into multiple portions, in accordance with embodiments of the present disclosure. FIGS. 4A-4C show three fixed division patterns, i.e., a horizontal partition (4A), a vertical partition (4B), and a quadrant partition (4C). Non-limiting examples of a block-wise division are shown in FIGS. 4D-4F. One skilled in the art can appreciate that other partition schemes are feasible, without departing from the scope of the present disclosure.

In one embodiment, the division pattern used in the codec can be predefined. Alternatively, with respect to a frame (e.g., an I frame), the encoder can choose one from a group of available division patterns, and inform the decoder of what division pattern is selected for the current frame, for example.

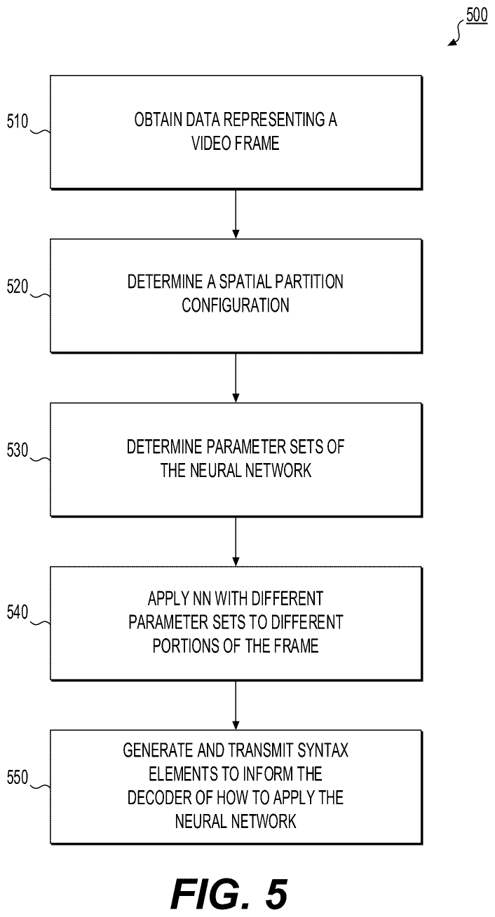

FIG. 5 shows a flow chart of a process 500 for implementing an NN-based in-loop filter in a video encoder, in accordance with embodiments of the disclosure. At step 510, data representing a video frame is obtained. For example, the frame is an I frame. As mentioned above, the data can be obtained at the output of the Reconstruction unit REC 135 or at the output of any of the filters (including but not limited to, DF 140, SAO 145, and ALF 150).

Given that the encoder has decided to activate the spatial partition mode, it is determined, at step 520, what spatial partition configuration will be adopted to divide the frame. As mentioned above, the spatial partition can be a predefined one; alternatively, the encoder can adaptively choose different spatial partitions for different frames. In addition, a spatial partition can be shared by all frames in a frame sequence. For example, in the case of an I frame, the encoder can choose one from the horizontal partition, the vertical partition, and the quadrant partition, or define a particular block-wise partition so as to divide the frame into a desired number of portions. If the frame is a B frame or a P frame, the encoder simply reuses the spatial partition determined for the I frame.

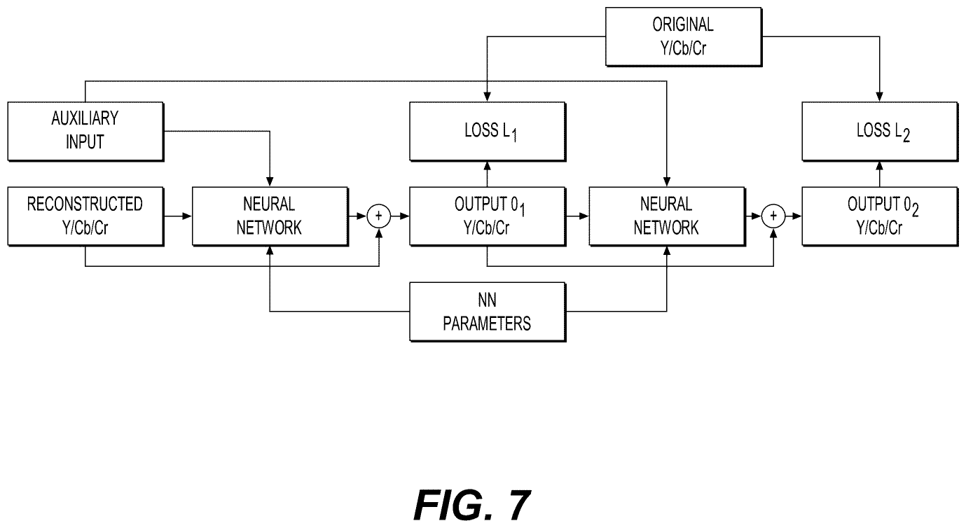

At step 530, parameter sets of the neural network are determined. That is, for individual portions of the frame, the encoder decides to use what parameter sets to build the neural network. For example, the left portion of the frame can correspond to the neural network with a parameter set θₗ, while the neural network developed with a parameter set θᵣ is applied to the right portion of the frame. The parameter sets θₗ and θᵣ can be completely distinct from each other. Alternatively, there can be some common parameters for certain layers, filters, weights, and/or biases of the neural network. Again, new parameter sets can be determined for an I frame, and if the frame is a P frame or a B frame, the parameter sets are those previously determined for the I frame. A training process for learning the neural network parameters will be described in detail with reference to FIGS. 7-9.

Based on the spatial partition determined at step 520 and the neural network parameter sets determined at step 530, the neural network is applied at step 540 to the portions of the frame. As each portion is processed by a neural network with a set of parameters specialized to this particular portion, the neural network can fit the corresponding error statistics with a small number of operations per pixel.

At step 550, the encoder generates and transmits to the decoder various syntax elements (flags), so as to indicate how to deploy the neural network at the decoder side. For example, a syntax element can indicate whether the spatial partition mode is active or inactive, and another syntax element can indicate the position of the neural network in the loop, etc.

Other syntax elements can indicate the spatial partition scheme, the parameter sets of the neural networks, and the correspondence between the multiple portions and the multiple parameter sets. The codec can use any combination of one or more fixed division patterns and/or one or more block-wise division patterns. In this situation, with respect to a certain frame, the encoder can transmit one or more syntax elements to indicate which division pattern is valid. Again, the spatial partition scheme can be predefined, instead of being signaled by syntax elements.

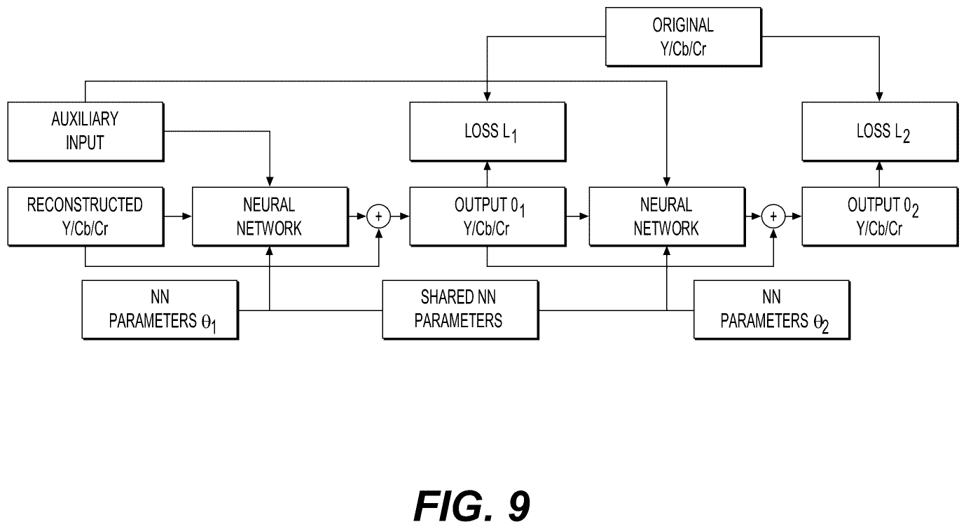

Optionally, further syntax elements can be used to indicate if and how the parameters are shared between two or more portions. In addition, when the neural network is trained through a multi-pass process as described in the below with reference to FIG. 9, a set of syntax elements can be used to indicate how to derive a parameter set for the current frame by replacing some parameters of a previously transmitted parameter set. The syntax elements mentioned above can be transmitted at the frame level, for example. A non-limiting example of the syntax elements will be given in Tables 1 and 2 below.

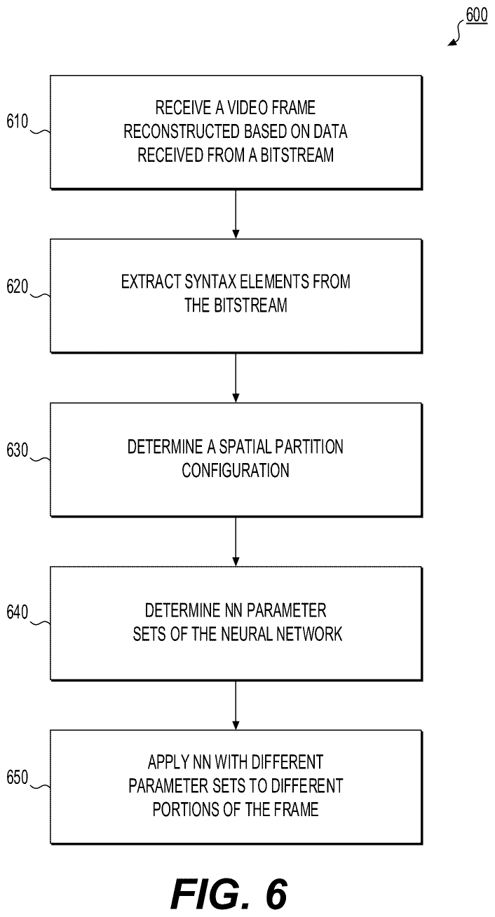

FIG. 6 shows a flow chart of a process for implementing an NN-based in-loop filter in a video decoder, in accordance with embodiments of the disclosure. The process 600 starts at step 610 by obtaining a video frame reconstructed based on data received from a bitstream. The video frame can be a reconstructed frame (from the output at REC 235) or a filtered reconstructed frame (from the output at DF 240, SAO 245, or ALF 250).

At step 620, syntax elements are extracted from the bitstream. One of the syntax elements can indicate whether the spatial partition mode is active or not, for example. Other syntax elements can indicate the spatial partition for dividing the frame, the neural network parameters, and how to develop the neural network with the parameters, etc. As mentioned above, some information can be predefined or reused. For example, for a P frame or a B frame, the spatial partition and the parameter sets determined previously can be reused, and thus no syntax elements are necessary for these frames.

Based on the parsed syntax elements (and optionally predefined information and/or reused information), a spatial partition configuration is determined at step 630 to divide the frame into a plurality of portions, and a plurality of neural network parameter sets are determined at step 640. At step 650, a neural network is developed with one of the plurality of parameter sets and applied to each of the plurality of portions of the frame.

Table 1 lists a set of syntax elements defined in a non-limiting example of the present disclosure. These syntax elements can be transmitted at the frame-level, and used to inform the decoder of various information, including but not limited to, whether the spatial division mode is active, which one of a group of spatial partition candidates is selected, whether new neural network parameters are available, how the portions share neural network parameters, and for a particular portion which parameter set is to be applied, etc.

TABLE 1
Exemplary syntax elements to signal spatial division
configuration and associated parameter sets

| # | Data type (maximum value) | Note |
|---|---|---|
| 1 | Boolean | Spatial Division Active |
| 2 | Boolean | If #1: New spatial division configuration indicator |
| 3 | Boolean | If #1: New network parameter sets indicator |
| 4 | Boolean | If #2: spatial division mode (fixed, block-wise) |
| 5 | Unsigned Integer (2) | If not #4: fixed spatial division mode (0: horizontal, 1: |
| | | vertical, 2: four divisions) |
| 6 | Unsigned Integer (8) | If #4: number of parameter sets |
| 7 | Unsigned Integer (<Number | If #4: for each portion, this indicates which parameter set is |
| | of parameter sets, i.e. #6) | used |
| 8 | Boolean | For each layer in the network: Are the layer's |
| | | parameters shared among the spatial divisions or not? |
| 9 | Integer (<Number of | For each layer if #8: number of different parameter group |
| | parameter sets) | for the layer |
| 10 | Integer (#9) | For each layer if #8, for each parameter set: the layer |
| | | parameter group that a particular layer in a particular |
| | | parameter set refers to |

In Table 1, the existence of a syntax element with a higher number (indicated by ‘#’) may be conditional on one with a lower number. The syntax element #1 indicates whether the spatial division mode is active or not. If the spatial division mode is active, #1 can be followed by two Boolean-type syntax elements #2 and #3. The syntax element #2 indicates whether a new spatial division configuration is transmitted and valid from this frame onward. The syntax element #3 indicates whether new network parameter sets are transmitted and valid from this frame onward. Note that after an I-frame, the syntax elements #2 and #3 may be not necessary, as there is no new partition configuration, and no new parameter sets to be transmitted.

If the syntax element #2 is set, then the syntax element #4 indicates the configuration of the spatial partition, i.e., what kind of spatial division pattern is used. The spatial division pattern can be a fixed spatial division where the frame is partitioned into two halves (upper/lower or left/right) or four quadrants of equal size. Otherwise, the spatial division pattern refers to a block-wise division where each portion is associated with one of the parameter sets. If the syntax element #4 indicates a fixed division, then the syntax element #5 signals which kind of partitioning is used. From the partitioning, the number of parameter sets required, P, can be inferred. On the other hand, if the syntax element #4 indicates a block-wise division, then the syntax element #6 contains the number of parameter sets, P, of which each portion chooses one. In addition, the syntax element #7 then contains a series of integers, one for each portion, that reference one of the parameter sets, the maximum value of each integer is therefore given by P−1.

If the syntax element #3 is set, new neural network parameter sets are transmitted and valid from the current frame onward. The parameter sets associated with different portions can be completely distinct, but this is not necessary. That is, the parameter sets can be partially shared among the portions at a layer level, a filter level, or an element-of-filter level.

For example, a neural network has a 5-layer structure; under a horizontal partition, the frame is divided into two halves. The neural network used for the upper half can share a same layer 1 and a same layer 5 with that used for the lower half, while the layers 2-4 are different for the two halves. In this situation, a sharing specification regarding how the neural network parameter sets are shared can be indicated by one or more syntax elements.

For example, the syntax element #8 indicates for each layer l of the neural network whether it is shared among parameter sets or not. If layer l is not shared, then there is a parameter group θₗ^{p} for each parameter set p. If l is shared, then the syntax element #9 indicates the total number of parameter groups, Gₗ, for layer l. Each parameter group θₗ^{g} needs to be associated with a parameter set. This information is signaled in the syntax element #10. For each layer and each of the parameter sets, an integer is signaled indicating which of the Gₗ parameter groups are referenced to construct the parameter set. Note that if Gₗ=1, that is, there is only one parameter group, it is not necessary to signal #10 for layer l.

In accordance with the signaled information, the decoder assembles the neural network with the parameter sets θ^{p}, and applies the neural network to associated portions of the frame.

Note that the set of syntax elements listed in Table 1 is not restrictive. For example, in one embodiment, only some fixed divisions are supported, and the block-wise division is not allowed; therefore, one or more syntax elements with different type, value range, and meaning from #2 and #3 can be defined. In another embodiment, for the syntax elements #8, #9, and #10, the parameters in one layer are shared or not is pre-determined without signaling. In yet another embodiment, for the syntax element #7, the selection can be signaled at CTU level with other syntax elements in one CTU. In further another embodiment, the spatial partition is predefined and does not need to be signaled.

As described in the above, a training process needs to be performed at the encoder side so as to derive the parameters of the neural network. When training a NN-based filter during or after encoding for a sequence of frames, only the decoded frames without the noise suppressing influence of the neural network is used as training data. If the neural network operates in a post-loop mode, the training data matches the test data (for example, to-be-processed data or decoded frame) exactly. When used as an in-loop filtering tool, however, the neural network will alter a frame fₐ which is then used as reference for a subsequently encoded frame f_{b}, for example. As the neural network was not available during the encoding pass that generated the training data, the frame f_{b} differs from the frame used during training, resulting in a difference in error statistics. In order to take into account the re-application of a trained neural network to its own output during the in-loop operation, a multi-pass training process is proposed.

FIG. 7 shows a block diagram of an exemplary multi-pass training process of a neural network in accordance with embodiments of the disclosure, in which a single set of neural network parameters is used in multiple passes. In FIG. 7, the first pass takes reconstructed data (representing by Reconstructed Y/Cb/Cr) as an input, and combines it with an Auxiliary Input such as motion vectors, residuals, and/or position information. The position information can inform the neural network of the position of the pixel being processed by the neural network, for example. The output from the first neural network is added to the Reconstructed Y/Cb/Cr to produce an output O₁. The output O₁ is used, together with the Auxiliary Input, to compute another pass of the neural network using the same parameters as in the first pass. Again, a second output O₂ is produced by adding the output of the second neural network to the Reconstructed Y/Cb/Cr. This process can continue for an arbitrary number of passes, creating a new output Oₙ in the n-th pass.

A loss can be calculated for each of the n outputs O₁, O₂, . . . , Oₙ by computing an error between that output and the original signal Y/Cb/Cr (the ground truth). To update the neural network parameters using the gradient descent algorithm, a final loss can be computed as [symbol] =Σₙ [symbol] wₙ, where the weights wₙ can be chosen arbitrarily. When the final loss has converged, the learned neural network parameters can be quantized and signaled to the decoder where the neural network is applied in-loop to the reconstructed Y/Cb/Cr. Note that as mentioned previously, filtered reconstructed data can be used in place of the reconstructed Y/Cb/Cr, for example, data outputted from any of DO, SAO, and ALF.

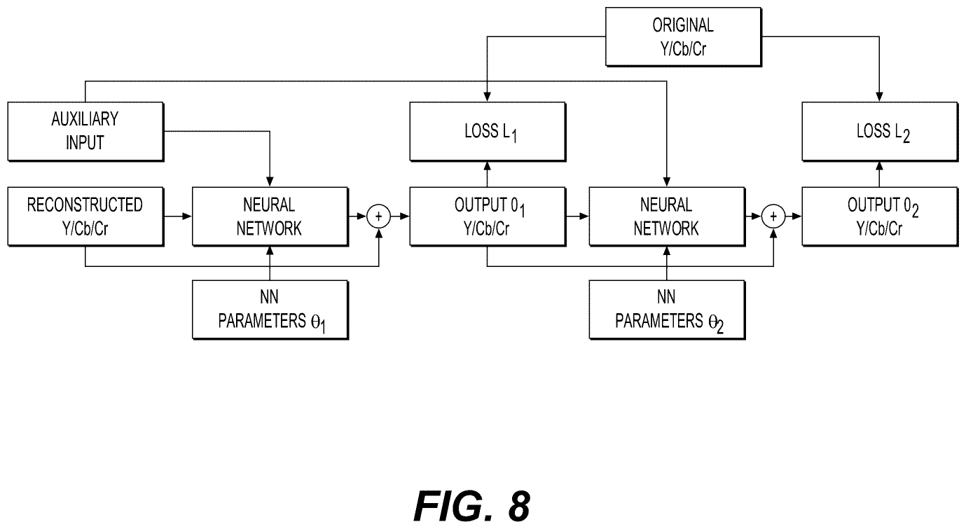

In the embodiment shown in FIG. 7, the multi-pass training process simulates that the output of a neural network is successively improved by the same neural network for one or more times. Other embodiments of the present disclosure can simulate that the output of the neural network is improved by one or more different or partially different neural networks, as shown in FIGS. 8 and 9.

FIG. 8 shows a block diagram of an exemplary multi-pass training process of a neural network in accordance with embodiments of the disclosure, in which different parameter sets are used in the multiple passes. In each pass, the neural network has a separate set of parameters, so there will be N sets of parameters for N passes. In a non-limiting example, only the first parameter set is signaled to the decoder, the other parameter sets are discarded. Alternatively, if the first n (n≤N) neural networks will be used in series, the first n parameter sets can be signaled.

The embodiment shown in FIG. 8 simulates the in-loop application of multiple neural networks trained on successive frames. For example, a set of neural network parameters θ₁ are trained and used in coding of a first group of frames; after that, another set of parameters θ₂ are trained and used in coding of a second group of frames. In this situation, the first set of parameters θ1 can be trained while taking into account that its output might be re-processed by a neural network with a different second parameter set θ₂ when content is referenced in a subsequent frame.

FIG. 9 shows a block diagram of an exemplary multi-pass training process of a neural network in accordance with embodiments of the disclosure, in which partially different parameter sets are used in the multiple passes. In this embodiment, the sets of neural network parameters θ₁, θ₂, . . . , θₙ are only partially distinct. Some of the parameters (referred to as “Shared NN Parameters” in FIG. 9) of each neural network are the same, others (referred to as “NN Parameters θ₁” and “NN Parameters θ₂”, for example) are specific to a single neural network. The distinction between the common and individual parameters can be layer-wise, filter-wise, or element-wise. With this mechanism, only the individual part of the parameters has to be signaled for subsequently trained neural networks, thereby reducing rate overhead.

To inform the decoder about which part of a neural network is being replaced, appropriate syntax elements can be inserted in the frame header as shown in Table 2 below.

TABLE 2
Exemplary syntax elements to signal parameter replacement

| | Data type/max value | Note |
|---|---|---|
| 1 | Boolean | New set of parameters |
| 2 | Unsigned Integer (Num. of | Reference to previously signaled network (0: new |
| | previously received networks) | complete set; 1: latest; 2: one before latest; . . . ) |
| 3 | Unsigned Integer (4) | Type of replacement (0: no replacement [end of |
| | | signaling]; 1: layer; 2: filter; 3: weight; 4: bias) |
| 4 | Unsigned Integer (Num. of layers in | Layer that (or in which a filter, weight or bias) |
| | network referenced in #2) | should be replaced. Present if #3 > 0. |
| 5 | Unsigned Integer (Num. of filters in | Filter (if #3 = 2) or bias (if #3 = 4) to be replaced. |
| | layer #4 of network referenced in #2) | Present if #3 > 1 |
| 6 | Unsigned Integer (Num. of weights | Weight to be replaced. Present if #3 = 3 |
| | in filter #5 of layer #4 of network | |
| | referenced in #2) | |

A syntax element #1 is a Boolean-type value for signaling if a new set network parameters is contained in the frame header, for example. If that is the case, a syntax element #2 will be present to indicate if a new complete set of parameters (the syntax element #2 set to 0) or only a partial set is signaled. In case of a partial set, the syntax element #2 indicates which network serves as a base, in which certain parts are then replaced, where the syntax element #2 is the index into a list of previously received network parameter sets (including those created through partial replacement of a base network parameter set). The index starts with 1 indicating the most recently received network parameter set.

If the syntax element #2 signals a replacement, then the syntax element #3 indicates the type of replacement. If the syntax element #3 is set to 0, it ends the replacement signaling. Otherwise, it indicates that either a layer (value: 1), a filter (value: 2), a weight (value: 3), or a bias (value: 4) is being replaced. A syntax element #4 specifies which layer of the neural network the replacement refers to. If the syntax element #3 denotes a filter, weight, or bias, the syntax element #5 will indicate the corresponding filter which is either completely replaced or in which a weight or a bias is replaced. If the syntax element #3 denotes a weight, then a syntax element #6 is present to indicate which weight is to be replaced.

With this information extracted, it is now possible to infer the datatype and the number of entries to be extracted from an entropy coder such as CABAC, VLC, or others. The datatype depends on whether a weight or a bias is being read and what datatype the previously signaled network uses to transmit parameters. Those datatypes can be Integers with up to 32 bit or Floating-point numbers with up to 32 bit. After the parameters have been decoded, another syntax element #3 is read. If it equals zero, the parameters of the new network are complete, otherwise the process proceeds as described until a syntax element #3 equaling 0 is read after reading parameters.

In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

Aspects of the present disclosure are further described as follows.

### I. Multiple-Pass Training for In-Loop Neural Network Filtering

Recent research results (See, e.g., References 1 and 2) have demonstrated that a small neural network (NN) that requires only hundreds of operations per pixel can achieve a coding gain if trained as post-loop filter on a limited set of up to several hundred frames and signaled to the decoder. The signaling happens either using quantized or original floating-point parameters.
Reference 1: J. P. Klopp, L.-G. Chen and S.-Y. Chien, Utilising Low Complexity CNNs to Lift Non-Local Redundancies in Video Coding, IEEE Transactions on Image Processing, 2020.
Reference 2: J. P. Klopp, K.-C. Liu, S.-Y. Chien and L.-G. Chen, Online-trained Upsampler for Deep Low Complexity Video Compression, in Proceedings of the IEEE CVF International Conference on Computer Vision, 2021.

In those works, the NN is applied as a post-loop filter after the decoding loop, i.e., the outputs of the NN are not used as reference for another frame. This limits the impact of the NN on noise reduction and coding gain as processed content is not reused. Applying the after-loop training process to the in-loop encoding process produces a mismatch between the training and testing data as the NN would have to process data that was created through referencing (e.g., motion compensation) its output. To mitigate this shortcoming, we propose a different training technique for in-loop application of NNs.

The proposed method uses a convolutional neural network (CNN) as image restoration method in a video coding system. For example, as shown in FIG. 1 and FIG. 2, we can apply the CNN to the ALF output picture and generate the final decoded picture. Or the CNN can be directly applied after SAO, DF, or REC, with or without other restoration methods in one video coding system, as shown in FIG. 1 and FIG. 2.

In order to take into account the re-application of the trained CNN to its own content during in-loop operation, multi pass training is proposed. When training a CNN during or after encoding for a sequence of frames, only the decoded frames without the noise suppressing influence of the CNN is used as training data. When operating in post-loop mode, this training data matches the test data exactly. In in-loop mode, however, the CNN will alter a frame fₐ which is then used as reference for a subsequently encoded frame f_{b}. The frame f_{b} will thereby differ from the frame used during training as the CNN was not available during the encoding pass that generated the training data.

In one embodiment, a single set of parameters is used to successively process the output as shown in FIG. 7. The first execution of the neural network takes the “Reconstructed Y/Cb/Cr” input from the decoder and combines it with “Auxiliary Input” such as motion vectors, residuals, or position information. The neural network's output is added to the “Reconstructed Y/Cb/Cr” to produce the output O₁. This output is used, together with the auxiliary input, to compute another pass of the neural network using the same parameters as before. Adding the output of this second pass to the “Reconstructed Y/Cb/Cr” produces output O₂. This process can continue for an arbitrary number of passes, creating a new output Oₙ in the n-th pass. For each output Oₙ, we can compute a loss [symbol] by computing the error between the output and the original Y/Cb/Cr. To update the neural network parameters using gradient descent, one final loss is computed as [symbol] =Σₙ [symbol] wₙ where the weights wₙ can be chosen arbitrarily. After training has completed, the neural network parameters can be quantized and signaled to the decoder where the neural network is applied in-loop to the reconstructed Y/Cb/Cr.

In another embodiment, it is proposed that each pass uses a neural network with a separate set of parameters as shown in FIG. 8. For N passes, there will be N sets of parameters. This simulates the in-loop application of multiple neural networks trained on successive frames. In in-loop processing, a set of parameters is trained while taking into account that its output might be re-processed by a different set when content is referenced in a subsequent frame. Only the first set or the first n≤N parameter sets are signaled to the decoder.

In yet another proposed instantiation of this training scheme, the sets of neural network parameters θₙ are only partially distinct as shown in FIG. 9. Some of the parameters of each neural network are shared, others are specific to a single neural network. The distinction between shared and individual parameters can be layer-wise, filter-wise or element-wise. With this mechanism, only the individual part of the parameters has to be signaled for subsequently trained neural networks, thereby reducing rate overhead. To inform the decoder about which part of a neural network is being replaced, appropriate flags are inserted in the frame header as shown in Table A: Flags to signal parameter replacement. Flag #1 is Boolean and signals if a new set network parameters is contained in the frame header. If that is the case, flag #2 will be present to indicate if a new complete set of parameters (flag #2 set to 0) or only a partial set is signaled. In case of a partial set, flag #2 indicates which network serves as base, in which certain parts are then replaced, where flag #2 is the index into the list of previously received networks (including those created through partial replacement of a base network). The index starts with 1 indicating the most recently received network. If flag #2 signals a replacement, then flag #3 indicates the type of replacement. If flag #3 is set to 0, it ends the replacement signaling. Otherwise it indicates that either a layer (value: 1), a filter (value: 2), a weight (value: 3), or a bias (value: 4) is being replaced. Flag #4 specifies which layer of the neural network the replacement refers to. If flag #3 denotes a filter, weight, or bias, flag #5 will indicate the corresponding filter which is either completely replaced or in which a weight or the bias is replaced. If flag #3 denotes a weight, then flag #6 is present to indicate which weight is to be replaced. With this information extracted, it is now possible to infer the datatype and the number of entries to be extracted from an entropy coder such as CABAC, VLC, or others. The datatype depends on whether a weight or a bias is being read and what datatype the previously signaled network uses to transmit parameters. Those datatypes can be Integers with up to 32 bit or Floating point numbers with up to 32 bit. After the parameters have been decoded, another flag #3 is read. If it equals zero, the parameters of the new network are complete, otherwise the process proceeds as described until a #3 flag equaling 0 is read after reading parameters.

TABLE A
Flags to parameter replacement

| | Data type/max value | Note |
|---|---|---|
| 1 | Boolean | New set of parameters |
| 2 | Unsigned Integer (Num. of | Reference to previously signaled network (0: new |
| | previously received networks) | complete set; 1: latest; 2: one before latest; . . . ) |
| 3 | Unsigned Integer (4) | Type of replacement (0: no replacement [end of |
| | | signaling]; 1: layer; 2: filter; 3: weight; 4: bias) |
| 4 | Unsigned Integer (Num. of layers in | Layer that (or in which a filter, weight or bias) |
| | network referenced in #2) | should be replaced. Present if #3 > 0. |
| 5 | Unsigned Integer (Num. of filters in | Filter (if #3 = 2) or bias (if #3 = 4) to be replaced. |
| | layer #4 of network referenced in #2) | Present if #3 > 1 |
| 6 | Unsigned Integer (Num. of weights | Weight to be replaced. Present if #3 = 3 |
| | in filter #5 of layer #4 of network | |
| | referenced in #2) | |

### II. Spatially Divided Training for In-Loop Neural Network Filtering

Recent research results (See, e.g., References 1-2) have demonstrated that a small neural network (NN) that requires only hundreds of operations per pixel can achieve a coding gain if trained as post-loop filter on a limited set of up to several hundred frames and signaled to the decoder. The signaling happens either using quantized or original floating-point parameters.

In those works, the NN is applied as a post-loop filter after the decoding loop, i.e., the outputs of the NN are not used as reference for another frame. This limits the impact of the NN on noise reduction and coding gain as processed content is not reused. Applying the after-loop training process to the in-loop encoding process produces a mismatch between the training and testing data as the NN would have to process data that was created through referencing (e.g., motion compensation) its output. To mitigate this shortcoming, we propose a different training technique for in-loop application of NNs.

The proposed method uses a convolutional neural network (CNN) as image restoration method in a video coding system. For example, as shown in FIG. 1 and FIG. 2, we can apply the CNN to the ALF output picture and generate the final decoded picture. Or the CNN can be directly applied after SAO, DF, or REC, with or without other restoration methods in one video coding system, as shown in FIG. 1 and FIG. 2.

Different areas of a sequence of frames often have different content. This may lead to different reconstruction error statistics that the CNN must learn in order to predict the error at each pixel. To account for different predictors required in different spatial areas of the frame sequence, spatially divided training is proposed. Spatially divided training divides the pixels in a frame into distinct groups. Each group has a parameter set Op that defines the predictor used for the pixels in the group. The parameter sets can but do not have to be distinct. Parameters, organized in filters, layers, or groups of can be shared among parameter sets.

The spatial division can be according to fixed division patterns, such as horizontal or vertical division into two half frames or block-wise, where the parameter set used can differ for each block.

Table B lists the flags that are used to signal the decoder if spatial division is active and the configurations for both the spatial partitions as well as the (possibly shared) parameter sets associated with those spatial partitions.

TABLE B
Flags to signal spatial division configuration and associated parameter sets

| # | Data type (maximum value) | Note |
|---|---|---|
| 1 | Boolean | Spatial Division Active |
| 2 | Boolean | If #1: New spatial division configuration indicator |
| 3 | Boolean | If #1: New network parameter sets indicator |
| 4 | Boolean | If #2: spatial division mode (fixed, block-wise) |
| 5 | Unsigned Integer (2) | If not #4: fixed spatial division mode (0: horizontal, |
| | | 1: vertical, 2: four divisions) |
| 6 | Unsigned Integer (8) | If #4: number of parameter sets |
| 7 | Unsigned Integer (<Number of | If #4: for each block, this indicates which parameter |
| | parameter sets, i.e. #6) | set is used |
| 8 | Boolean | For each layer in the network: Are the layer's |
| | | parameters shared among the spatial divisions or not? |
| 9 | Integer (<Number of parameter | For each layer if #8: number of different parameter |
| | sets) | group for the layer |
| 10 | Integer (#9) | For each layer if #8, for each parameter set: the layer |
| | | parameter group that a particular layer in a particular |
| | | parameter set refers to |

These flags are signaled at frame-level. The existence of flags with a higher number (indicated by “#”) may be conditional on flags with a lower number. The first flag indicates whether spatial division is active or not. If that is the case, it is followed by two Boolean flags, the first of which indicates whether a new spatial division configuration is transmitted and valid from this frame onward. The second one indicates whether a new network parameter set is transmitted and valid from this frame onward.

If flag #2 is set, then flag #4 indicates what kind of spatial division is used. This can either be a fixed spatial division where the frame is partitioned into two halves (upper/lower or left/right) or four quadrants of equal size. Otherwise, it refers to a block-wise division where each block is associated with one of the parameter sets. If #4 indicates a fixed division, then #5 signals which kind of partitioning is used. From the partitioning, the number of parameter sets required, P, can be inferred. On the other hand, if #4 indicates block-wise division, then #6 contains the number of parameter sets, P, of which each block choses one. In addition, #7 then contains a series of integers, one for each block, that reference one of the parameter sets, the maximum value of each integer is therefore given by P−1.

If flag #3 is set, then flag #8 indicates for each layer l whether it is shared among parameter sets or not. If layer l is not shared, then there is a parameter group θₗ^{p} for each parameter set p. If l is shared, then #9 indicates the total number of parameter groups, Gₗ, for layer l. Each parameter group θₗ^{g} needs to be associated with a parameter set. This information is signaled in flag #10. For each layer and each of the parameter sets, an integer is signaled indicating which of the Gₗ parameter groups are referenced to construct the parameter set. Note that if Gₗ=1, that is, there is only one parameter group, signaling #10 is not necessary for layer l.

Note then after an I-frame, the flags #2 and #3 are not necessary, as there is no partition configuration, and no parameter sets available.

With the signaled information, the decoder assembles the parameter sets θ^{p}, which determine the function of the CNN. The CNN is then be applied to the restored image as for example described in References 3-5 where the parameter set is chosen according to which pixel(s) are being reconstructed.
Reference 3: C.-Y. Chen, T.-D. Chuang, Y.-W. Huang and J. P. Klopp, Method and Apparatus of Neural Networks with Grouping for Video Coding, U.S. patent application Ser. No. 16/963,566, 25 Feb. 2021.
Reference 4: Y.-L. Hsiao, Y.-C. Su, J. P. Klopp, C.-Y. Chen, T.-D. Chuang, C.-W. Hsu and Y.-W. Huang, Method and Apparatus of Neural Network for Video Coding, U.S. patent application Ser. No. 17/047,244, 3 Jun. 2021.
Reference 5: Y.-C. Su, J. P. Klopp, C.-Y. Chen, T.-D. Chuang, and Y.-W. Huang, Method and Apparatus of Neural Network for Video Coding, U.S. patent application Ser. No. 16/646,624, 6 Aug. 2020.

The description in the above is an example. It is not necessary to apply all parts in the above method together. For example, in one embodiment, for flag #2, only some fixed divisions are supported, and the block-wise division is not allowed. In another embodiment, for syntax #8, #9, and #10, the parameters in one layer are shared or not is pre-determined without signaling. In another embodiment, for syntax #7, the selection is signaled at CTU level with other syntax elements in one CTU.

Any of the foregoing proposed methods can be implemented in encoders and/or decoders. For example, any of the proposed methods can be implemented in in-loop filtering process of an encoder, and/or a decoder. Alternatively, any of the proposed methods can be implemented as a circuit coupled to the in-loop filtering process of the encoder and/or the decoder, so as to provide the information needed by the in-loop filtering process.

Those skilled in the art will also understand that there can be many variations made to the operations of the techniques explained above while still achieving the same objectives of the disclosure. Such variations are intended to be covered by the scope of this disclosure. As such, the foregoing descriptions of embodiments of the disclosure are not intended to be limiting. Rather, any limitations to embodiments of the disclosure are presented in the following claims.

What is claimed is:

1. A method for video decoding, comprising:
receiving a video frame reconstructed based on data received from a bitstream;
extracting, from the bitstream, a first syntax element indicating whether a spatial partition for partitioning the video frame is active; and
responsive to the first syntax element indicating that the spatial partition for partitioning the video frame is active:
determining a configuration of the spatial partition for partitioning the video frame,
determining a plurality of parameter sets of a neural network, and
applying the neural network to the video frame, wherein
the video frame is spatially divided based on the determined configuration of the spatial partition for partitioning the video frame into a plurality of portions, and the neural network is applied to the plurality of portions in accordance with the determined plurality of parameter sets.

2. The method of claim 1, wherein the step of determining the configuration further comprises:
extracting, from the bitstream, a second syntax element indicating whether a new configuration is available,
when the second syntax element indicates that no new configuration is available, using a configuration determined for a previous video frame as the determined configuration, and
when the second syntax element indicates that a new configuration is available, obtaining the new configuration from the bitstream, and using the obtained configuration as the determined configuration.

3. The method of claim 2, wherein the step of obtaining the new configuration further comprises:
extracting, from the bitstream, a first group of one or more further syntax elements indicating a particular configuration, and
identifying the particular configuration as the new configuration.

4. The method of claim 3, wherein the particular configuration is:
a horizontal partition, by which the video frame is divided into an upper portion and a lower portion,
a vertical partition, by which the video frame is divided into a left portion and a right portion,
a quadrant partition, by which the video frame is divided into an upper left portion, an upper right portion, a lower left portion, and a lower right portion, or
a block-wise partition, by which the video frame is divided into a particular number of portions, and the particular number is neither 2 nor 4.

5. The method of claim 1, wherein the step of determining the configuration further comprises using a predefined configuration as the determined configuration, and the predefined configuration is:
a horizontal partition, by which the video frame is divided into an upper portion and a lower portion,
a vertical partition, by which the video frame is divided into a left portion and a right portion,
a quadrant partition, by which the video frame is divided into an upper left portion, an upper right portion, a lower left portion, and a lower right portion, or
a block-wise partition, by which the video frame is divided into a predefined number of portions, and the predefined number is neither 2 nor 4.

6. The method of claim 1, wherein the step of determining the plurality of parameter sets further comprises:
extracting, from the bitstream, a third syntax element indicating whether a new plurality of parameter sets are available,
when the third syntax element indicates that no new parameter sets are available, using a plurality of parameter sets determined for a previous video frame as the determined plurality of parameter sets, and
when the third syntax element indicates that a new plurality of parameter sets are available, obtaining the new plurality of parameter sets from the bitstream, and using the obtained plurality of parameter sets as the determined plurality of parameter sets.

7. The method of claim 6, wherein the step of obtaining the new plurality of parameter sets further comprises:
extracting, from the bitstream, a second group of one or more further syntax elements indicating a particular plurality of parameter sets, and
identifying the particular plurality of parameter sets as the new plurality of parameter sets.

8. The method of claim 6, wherein the step of obtaining the new plurality of parameter sets further comprises:
extracting, from the bitstream, a second group of one or more further syntax elements indicating a particular previous video frame and a replacement specification, the replacement specification defining a replacement to some of a plurality of parameter sets determined for the particular previous video frame, and
generating, based on the plurality of parameter sets determined for the particular previous video frame and the replacement specification, the new plurality of parameter sets.

9. The method of claim 8, wherein the replacement is at a layer-level, a filter-level, or an element-of-filter-level of the neural network.

10. The method of claim 6, wherein the step of obtaining the new plurality of parameter sets further comprises:
extracting, from the bitstream, a second group of one or more further syntax elements indicating a particular plurality of parameter sets,
extracting, from the bitstream, a third group of one or more further syntax elements indicating a sharing specification, the sharing specification defining that some of the particular plurality of parameter sets are shared among two or more of the plurality of portions, and
generating the new plurality of parameter sets based on the particular plurality of parameter sets, in accordance with the sharing specification.

11. The method of claim 10, wherein the some of the particular plurality of parameter sets are shared among the two or more of the plurality of portions at a layer-level, a filter-level, or an element-of-filter-level of the neural network.

12. The method of claim 6, wherein the step of obtaining the new plurality of parameter sets further comprises:
extracting, from the bitstream, a second group of one or more further syntax elements indicating a particular plurality of parameter sets, and
generating the new plurality of parameter sets based on the particular plurality of parameter sets, in accordance with a predefined sharing specification defining that some of the particular plurality of parameter sets are shared among two or more of the plurality of portions.

13. The method of claim 1, wherein the step of determining the plurality of parameter sets further comprises:
extracting, from the bitstream, a fourth group of one or more further syntax elements indicating a correspondence specification, the correspondence specification defining a correspondence between one of the plurality of portions and each of the determined plurality of parameter sets,
and the step of applying the neural network further comprises:
applying, based on the correspondence specification, the neural network having one of the determined plurality of parameter sets to a corresponding one of the plurality of portions.

14. The method of claim 1, wherein the video frame is received from an output of a reconstruction unit (REC), an adaptive loop filter (ALF), a sample adaptive offset filter (SAO), or a deblocking filter (DF).

15. An apparatus for video decoding, comprising circuitry configured to:
receive a video frame reconstructed based on data received from a bitstream;
extract, from the bitstream, a first syntax element indicating whether a spatial partition for partitioning the video frame is active; and
responsive to the first syntax element indicating that the spatial partition for partitioning the video frame is active:
determine a configuration of the spatial partition for partitioning the video frame,
determine a plurality of parameter sets of a neural network, and
apply the neural network to the video frame, wherein the video frame is spatially divided based on the determined configuration into a plurality of portions, and the neural network is applied to the plurality of portions in accordance with the determined plurality of parameter sets.

16. A method for video encoding, comprising:
receiving data representing a video frame;
determining a configuration of a spatial partition for partitioning the video frame;
determining a plurality of parameter sets of a neural network; and
applying the neural network to the video frame, wherein the video frame is spatially divided based on the determined configuration into a plurality of portions, and the neural network is applied to the plurality of portions in accordance with the determined plurality of parameter sets; and
signaling a plurality of syntax elements associated with the spatial partition for partitioning the video frame.

17. The method of claim 16, further comprising:
training the neural network through a cascade of N (N≥2) training stages, so as to learn each of the plurality of parameter sets,
wherein each training stage comprises the neural network to be trained,
given 2≤n≤N, an input of an n-th training stage is derived based on an output of an (n−1)-th training stage,
data representing a reconstructed video frame is used as training data inputted to a first training stage,
data representing an original video frame of the reconstructed video frame is used as a ground truth, and
a total loss is calculated as a weighted sum of losses of the N training stages.

18. The method of claim 17, wherein the neural networks in the N training stages are developed with a same parameter set, or with N parameter sets specific to individual training stages.

19. The method of claim 17, wherein the neural networks in the N training stages are developed with parameter sets partially shared among the N training stages at a layer-level, a filter-level, or an element-of-filter level.

20. The method of claim 17, wherein the data representing the reconstructed video frame is obtained from an output of a reconstruction unit (REC), an adaptive loop filter (ALF), a sample adaptive offset filter (SAO), or a deblocking filter (DF).
